(19) United States
(12) Patent Application Publication
(10) Pub. No.: US 2026/0131432 A1
(43) Pub. Date: May 14, 2026

(54) RATCHET DRIVER

(71) Applicant: William Tools Co., Ltd., Taichung City (TW)

(72) Inventor: Shui-Lai Chiang, Taichung City (TW)

(21) Appl. No.: 19/348,930

(22) Filed: Oct. 3, 2025

(30) Foreign Application Priority Data
Nov. 12, 2024 (TW) 113143425

(51) Int. Cl. B25B 15/04

(52) U.S. Cl. CPC B25B 15/04

(57) ABSTRACT

A ratchet driver is provided, wherein the ratchet driver includes: a grip unit including a grip portion and a base; a drive rod rotatably disposed on the base; a rotatable member rotatably assembled to the base, and including a first positioning hole, two second positioning holes and two pushing portions; a positioning assembly disposed on the drive rod and including an elastic member between the drive rod and the positioning member, and a positioning member radially engageable in the first positioning hole or the second positioning hole; and a ratchet mechanism including a ratchet ring, and two engaging assemblies selectively engageable with the ratchet ring, the engaging portion including teeth, the spring elastically abutting between the engaging portion and the seat of the engaging assembly so that the teeth are normally urged to mesh with the ratchet ring, and the seat slidably abuts the ratchet ring.

### BACKGROUND OF THE INVENTION

### FIELD OF THE INVENTION

The present invention relates to a driving tool, particularly to a ratchet driver.

### DESCRIPTION OF THE PRIOR ART

A screwdriver is a tool specifically used to drive screws. The screwdriver has a shape matching the screw. Common shapes of the screwdrivers include a flat shape, a cross shape, a hexagonal shape, a star shape, and so on. A basic structure of the screwdriver is that a drive rod is inserted in a handle, and a hand drives the handle to drive the drive rod to rotate. Kinds of screwdrivers are like ones disclosed in TW I680841, TW M576090, and TW M524240.

However, when the above-mentioned screwdriver is used, a hand must continuously change a gripping position to allow the drive rod to continuously rotate in a specific direction, which is less convenient in operation and cannot be smoothly used in a narrow space.

The present invention is, therefore, arisen to obviate or at least mitigate the above-mentioned disadvantages.

### SUMMARY OF THE INVENTION

The main object of the present invention is to provide a ratchet driver, which, through a ratchet mechanism, allows a user to perform small-angle reciprocating rotations without changing a hand position to loosen and tighten, so it is not only suitable for use in a narrow space but also can effectively improve work efficiency.

To achieve the above and other objects, a ratchet driver is provided, wherein the ratchet driver includes: a grip unit including a grip portion and a base connected to each other; a drive rod rotatably disposed on the base, and defining an axial direction, a radial direction and a circumferential direction; a rotatable member assembled to the base in the axial direction and rotatable relative to the drive rod about the drive rod, an inner surface of the rotatable member facing the drive rod including a first positioning hole, two second positioning holes and two pushing portions arranged at intervals along the circumferential direction, the first positioning hole being located between the two second positioning holes; a positioning assembly disposed on the drive rod and including an elastic member and a positioning member, the elastic member elastically abutting between the drive rod and the positioning member so that the positioning member is radially engageable in one of the first positioning hole and the two second positioning holes; and a ratchet mechanism including a ratchet ring and two engaging assemblies, the ratchet ring being disposed around an inner surface of the base, the two engaging assemblies being respectively disposed on opposite sides of the drive rod and selectively engageable with the ratchet ring, each of the two engaging assemblies including a driving portion, an engaging portion, a spring and a seat, the driving portion and the engaging portion being integrally connected to each other, the engaging portion being located on an inner side of the ratchet ring, the driving portion protruding beyond the ratchet ring and located on an inner side of the rotatable member, a portion of the driving portion being located on a moving path of the pushing portion, the engaging portion, the spring and the seat being arranged in a straight line in a direction perpendicular to the axial direction, a side of the engaging portion facing away from the seat including a plurality of teeth, the spring elastically abutting between the engaging portion and the seat so that the plurality of teeth are normally urged to mesh with the ratchet ring, and the seat slidably abutting against the ratchet ring; wherein when the rotatable member is rotated such that the positioning member is engaged in the first positioning hole, the two pushing portions do not push against the driving portions of the two engaging assemblies, and the engaging portions of the two engaging assemblies engage with the ratchet ring such that the grip unit and the drive rod are rotatable with each other; wherein when the rotatable member is rotated such that the positioning member is engaged in one of the two second positioning holes, one of the pushing portions pushes one of the driving portions along the circumferential direction toward the seat to drive the plurality of teeth of one of the engaging portions to disengage from the ratchet ring such that the drive rod and the grip unit rotatable with each other unidirectionally and idle in a reversed direction.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of an exemplary embodiment of the present invention;

FIG. 2 is a partial exploded view of FIG. 1;

FIG. 3 is a partial cross-sectional view of FIG. 1;

FIG. 4 is a schematic view of a rotatable member and a drive rod when a positioning member is located in a first positioning hole in an exemplary embodiment of the present invention;

FIG. 5 is a cross-sectional view taken along line A-A of FIG. 4;

FIG. 6 is a cross-sectional view taken along line B-B of FIG. 4;

FIG. 7 is a schematic view of the rotatable member and the drive rod when the positioning member is located in a second positioning hole in an exemplary embodiment of the present invention;

FIG. 8 is a cross-sectional view taken along line C-C of FIG. 7; and

FIG. 9 is a cross-sectional view taken along line D-D of FIG. 7.

### DETAILED DESCRIPTION OF THE PREFERRED EMBODIMENTS

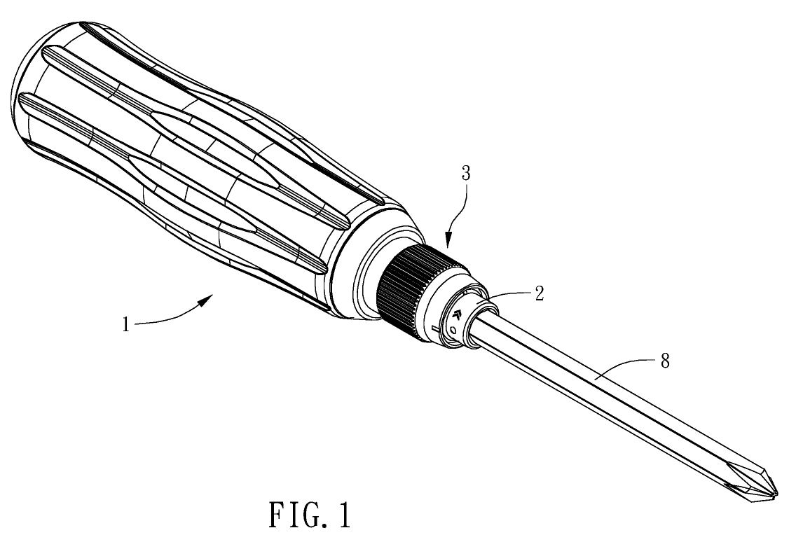

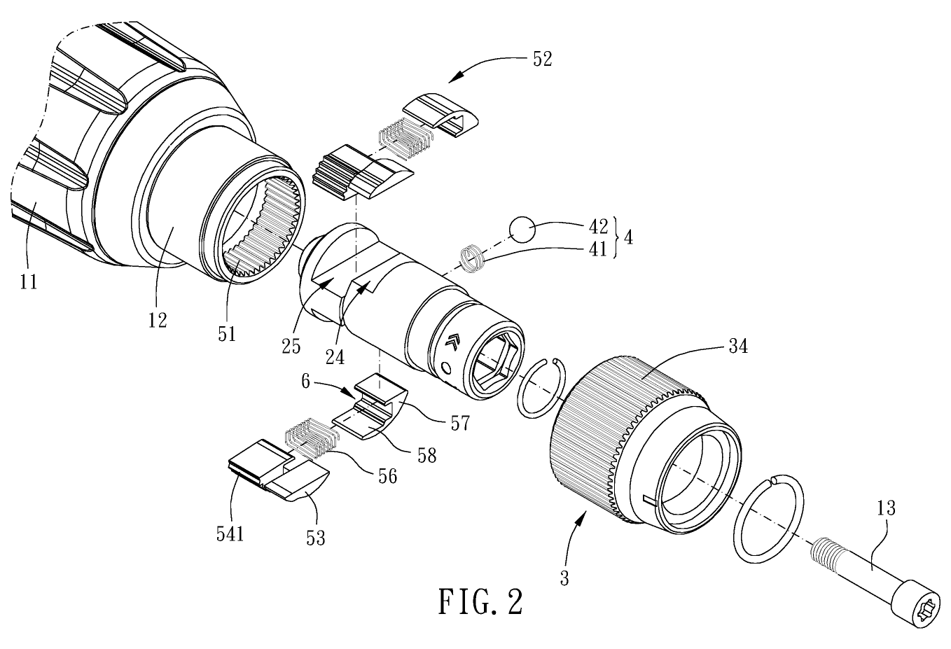

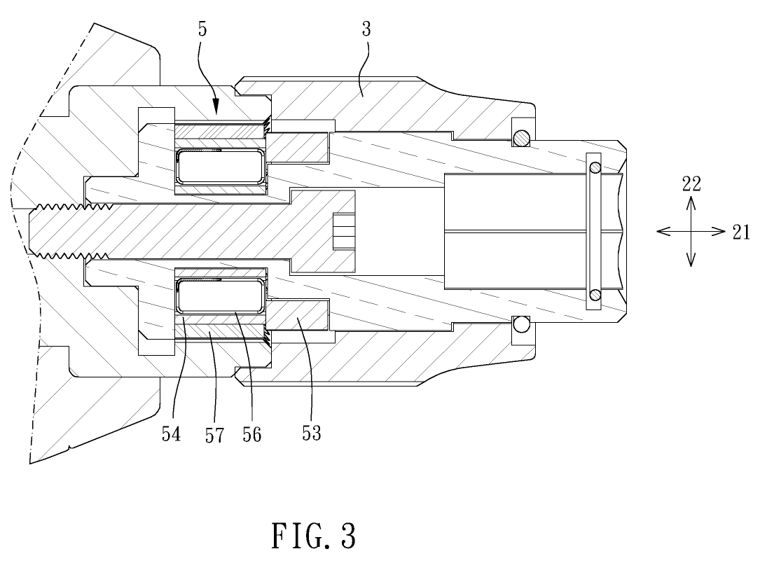

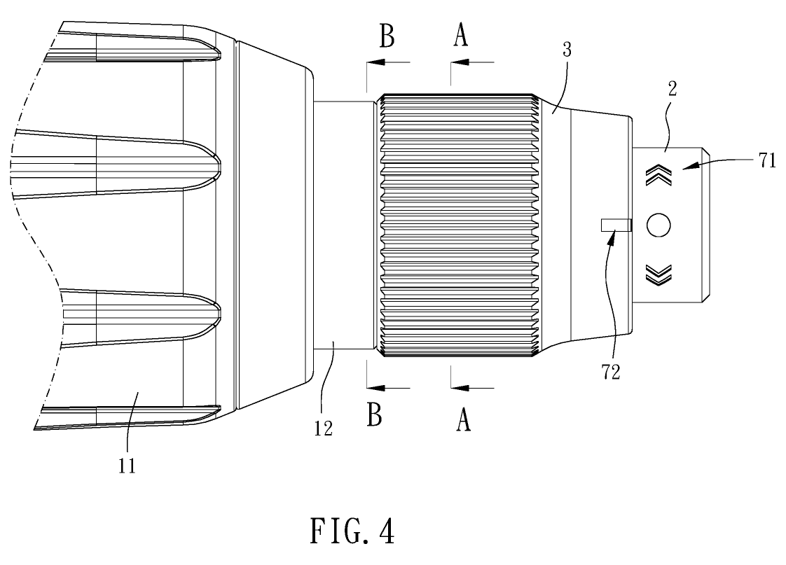

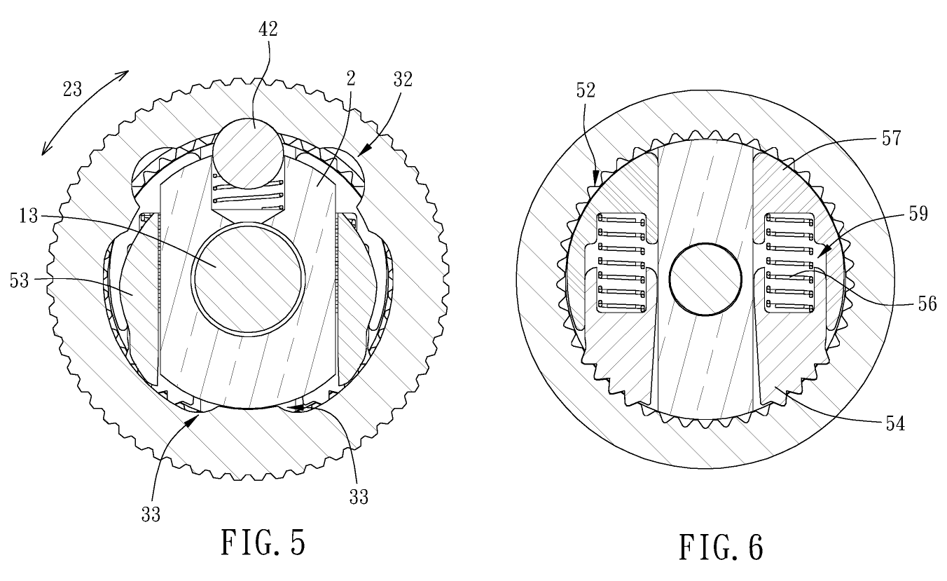

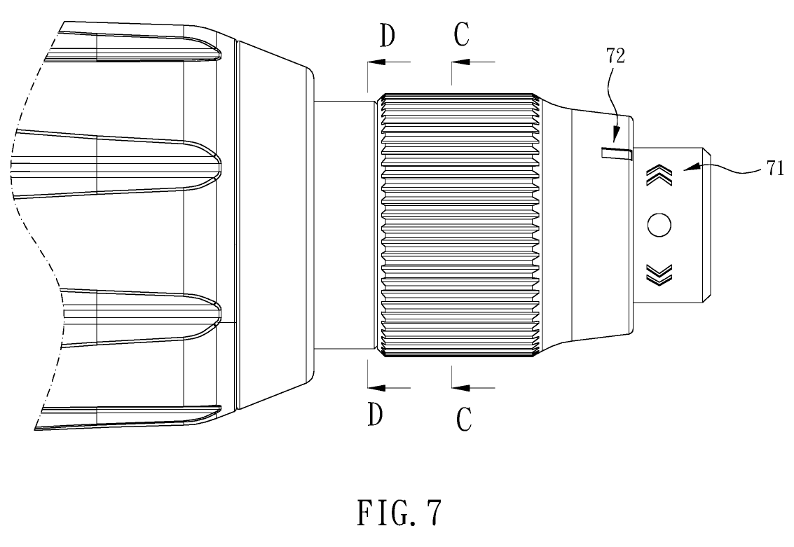

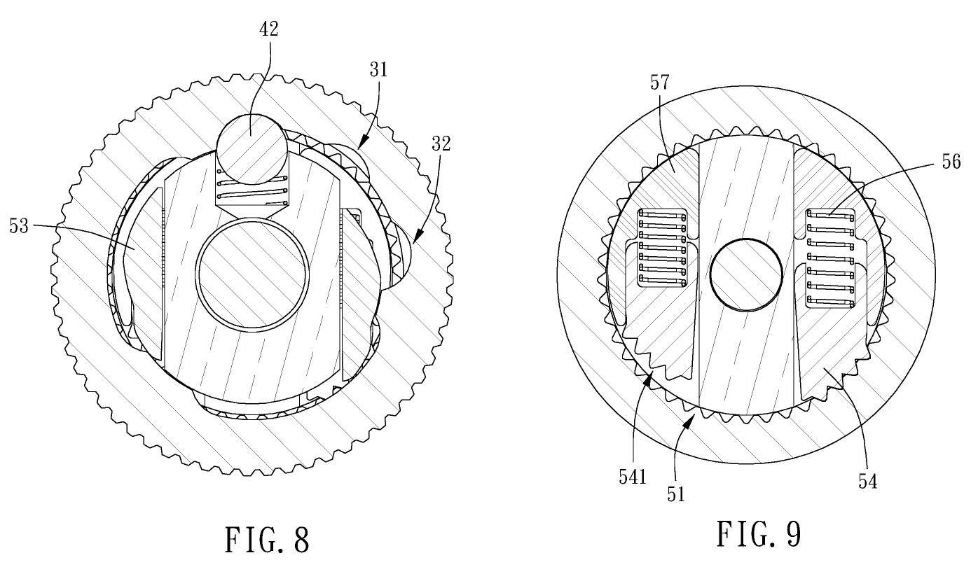

Please refer to FIGS. 1 to 9 for an exemplary embodiment of the present invention. A ratchet driver of the present invention includes a grip unit 1, a drive rod 2, a rotatable member 3, a positioning assembly 4, and a ratchet mechanism 5.

The grip unit 1 includes a grip portion 11 and a base 12 connected to each other. Preferably, the grip portion 11 is made of a plastic material, which is more comfortable for gripping. The drive rod 2 is rotatably disposed on the base 12. Specifically, a bolt 13 passes through the drive rod 2 and is screwed to the base 12, and the drive rod 2 is rotatable about the bolt 13. In addition, an end of the drive rod 2 away from the grip unit 1 includes a coupling portion configured to be coupled to a tool bit 8. The drive rod 2 defines an axial direction 21, a radial direction 22, and a circumferential direction 23.

The rotatable member 3 is assembled to the base 12 in the axial direction 21 and is rotatable relative to the drive rod 2 about the drive rod 2. An inner surface of the rotatable member 3 facing the drive rod 2 includes a first positioning hole 31, two second positioning holes 32 and two pushing portions 33 arranged at intervals along the circumferential direction 23, and the first positioning hole 31 is located between the two second positioning holes 32. The first positioning hole 31, the two second positioning holes 32 and the two pushing portions 33 are respectively located on opposite sides of the rotatable member 3.

Preferably, a rugged structure 34 is arranged on an outer circumferential wall of the rotatable member 3, and the rugged structure 34 can increase a contact area with a hand, thereby allowing the hand to easily drive the rotatable member 3 to rotate.

The positioning assembly 4 is disposed on the drive rod 2. The positioning assembly 4 includes an elastic member 41 and a positioning member 42. The elastic member 41 elastically abuts between the drive rod 2 and the positioning member 42 so that the positioning member 42 is radially engageable in one of the first positioning hole 31 and the two second positioning holes 32 in the radial direction 22. The positioning member 42 is spherical.

Preferably, one of an outer circumferential wall of the drive rod 2 and an outer circumferential wall of the rotatable member 3 includes a plurality of first marks 71, and the other of the outer circumferential wall of the drive rod 2 and the outer circumferential wall of the rotatable member 3 includes a second mark 72. The plurality of first marks 71 respectively radially correspond to the first positioning hole 31 and the two second positioning holes 32 in the radial direction 22. The second mark 72 radially corresponds to the positioning member 42 in the radial direction 22, and the second mark 72 is selectively aligned with one of the plurality of first marks 71 in the axial direction 21, so that a user can visually recognize them.

The ratchet mechanism 5 includes a ratchet ring 51 and two engaging assemblies 52. The ratchet ring 51 is disposed around an inner surface of the base 12. The two engaging assemblies 52 are respectively disposed on opposite sides of the drive rod 2 and are selectively engageable with the ratchet ring 51. Specifically, each of the engaging assemblies 52 includes a driving portion 53, an engaging portion 54, a spring 56 and a seat 57. The driving portion 53 and the engaging portion 54 are integrally connected to each other. The engaging portion 54 is located on an inner side of the ratchet ring 51. The driving portion 53 is protrusive beyond the ratchet ring 51 and is located on an inner side of the rotatable member 3. A portion of the driving portion 53 is located on a moving path of the pushing portion 33. The engaging portion 54, the spring 56 and the seat 57 are arranged in a straight line in a direction perpendicular to the axial direction 21, so that a shorter stroke can rapidly trigger a response. A side of the engaging portion 54 facing away from the seat 57 includes a plurality of teeth 541. The spring 56 elastically abuts between the engaging portion 54 and the seat 57 so that the plurality of teeth 541 are normally urged to mesh with the ratchet ring 51. The seat 57 slidably abuts against the ratchet ring 51.

Furthermore, the driving portion 53 and the engaging portion 54 are arranged in an offset arrangement along the axial direction 21, to respectively correspond to the rotatable member 3 and the ratchet ring 51, which can effectively utilize space and allow the driving portion 53 and the engaging portion 54 to have larger dimensions in the axial direction 21, thereby improving structural strength.

In use, when the rotatable member 3 is rotated such that the positioning member 42 is engaged in the first positioning hole 31, the two pushing portions 33 do not push against the driving portions 53 of the two engaging assemblies 52, and the engaging portions 54 of the two engaging assemblies 52 engage with the ratchet ring 51 such that the grip unit 1 and the drive rod 2 are rotatable with each other in both directions. When the rotatable member 3 is rotated such that the positioning member 42 is engaged in one of the two second positioning holes 32, one of the pushing portions 33 pushes one of the driving portions 53 along the circumferential direction 23 toward the seat 57 to drive a plurality of teeth 541 of the engaging portion 54 to disengage from the ratchet ring 51 such that the drive rod 2 and the grip unit 1 are rotatable with each other unidirectionally and idle in a reversed direction. A user can, without changing a hand position, perform small-angle reciprocating rotations to allow the drive rod 2 to continuously rotate in a specific direction to loosen and tighten, which is suitable for use in a narrow space and can effectively improve work efficiency.

Specifically, two sides of the drive rod 2 respectively include a first slot 24 and a second slot 25 recessed in the radial direction 22. The first slot 24 and the second slot 25 are arranged along the axial direction 21 and in communication with each other. The driving portion 53 is received in the first slot 24, and the engaging portion 54, the spring 56 and the seat 57 are received in the second slot 25. Specifically, the driving portion 53 is spaced apart from a wall of the first slot 24 to ensure that the driving portion 53 has sufficient moving space without jamming. In addition, the driving portion 53 is partially overlapped with the engaging portion 54, the spring 56 and the seat 57 in the axial direction 21, thereby providing a constraining effect for stable operation.

In this embodiment, the seat 57 is assembled to the drive rod 2 so that the seat 57 is convenient to process, and the seat 57 may be made of a material different from that of the drive rod 2 to meet different requirements. In addition, the seat 57 further includes a guide wall 58, and the guide wall 58 and the drive rod 2 define a space 59. The engaging portion 54 abuts against the guide wall 58 and is linearly and movably inserted in the space 59 in a stable manner. Furthermore, an end of the engaging portion 54 adjacent to 57 laterally abuts against a wall of the second slot 25, and a side of the engaging portion 54 facing the wall of the second slot 25 gradually departs from the wall of the second slot 25 from the seat 57 toward the plurality of teeth 541, thereby reducing friction and allowing the engaging portion 54 to slide in a rapid response.

The spring 56 is preferably a rectangular spring, which can have a higher energy storage capacity, higher fatigue resistance, excellent stability, and durability. In addition, the spring 56 can provide a larger abutting area to effectively reduce lateral movement and deformation during operation. For example, but not limited to, sides of the engaging portion 54 and the seat 57 facing each other are respectively recessed to form a receiving room 6, and two ends of the spring 56 are respectively received in the receiving rooms 6 of the engaging portion 54 and the receiving room 6 of the seat 57. In addition, in the axial direction 21, a height of the spring 56 is equal to a height of the engaging portion 54.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A ratchet driver including:
a grip unit including a grip portion and a base connected to each other;
a drive rod rotatably disposed on the base, and defining an axial direction, a radial direction and a circumferential direction;
a rotatable member assembled to the base in the axial direction and rotatable relative to the drive rod about the drive rod, an inner surface of the rotatable member facing the drive rod including a first positioning hole, two second positioning holes and two pushing portions arranged at intervals along the circumferential direction, the first positioning hole being located between the two second positioning holes;
a positioning assembly disposed on the drive rod and including an elastic member and a positioning member, the elastic member elastically abutting between the drive rod and the positioning member so that the positioning member is radially engageable in one of the first positioning hole and the two second positioning holes; and
a ratchet mechanism including a ratchet ring and two engaging assemblies, the ratchet ring being disposed around an inner surface of the base, the two engaging assemblies being respectively disposed on opposite sides of the drive rod and selectively engageable with the ratchet ring, each of the two engaging assemblies including a driving portion, an engaging portion, a spring and a seat, the driving portion and the engaging portion being integrally connected to each other, the engaging portion being located on an inner side of the ratchet ring, the driving portion protruding beyond the ratchet ring and located on an inner side of the rotatable member, a portion of the driving portion being located on a moving path of the pushing portion, the engaging portion, the spring and the seat being arranged in a straight line in a direction perpendicular to the axial direction, a side of the engaging portion facing away from the seat including a plurality of teeth, the spring elastically abutting between the engaging portion and the seat so that the plurality of teeth are normally urged to mesh with the ratchet ring, and the seat slidably abutting against the ratchet ring;
wherein when the rotatable member is rotated such that the positioning member is engaged in the first positioning hole, the two pushing portions do not push against the driving portions of the two engaging assemblies, and the engaging portions of the two engaging assemblies engage with the ratchet ring such that the grip unit and the drive rod are rotatable with each other;
wherein when the rotatable member is rotated such that the positioning member is engaged in one of the two second positioning holes, one of the pushing portions pushes one of the driving portions along the circumferential direction toward the seat to drive the plurality of teeth of one of the engaging portions to disengage from the ratchet ring such that the drive rod and the grip unit rotatable with each other unidirectionally and idle in a reversed direction.

2. The ratchet driver of claim 1, wherein the spring is a rectangular spring.

3. The ratchet driver of claim 2, wherein sides of the engaging portion and the seat facing each other each include a receiving room, and two ends of the spring are respectively received in the receiving rooms of the engaging portion and the seat.

4. The ratchet driver of claim 1, wherein, in the axial direction, a height of the spring is equal to a height of the engaging portion.

5. The ratchet driver of claim 1, wherein two sides of the drive rod respectively include a first slot and a second slot recessed in the radial direction, the first slot and the second slot are arranged along the axial direction and in communication with each other, the driving portion is received in the first slot, and the engaging portion, the spring and the seat are received in the second slot.

6. The ratchet driver of claim 5, wherein the driving portion is spaced apart from a wall of the first slot.

7. The ratchet driver of claim 5, wherein an end of the engaging portion adjacent to the seat laterally abuts against a wall of the second slot, and a side of the engaging portion facing the wall of the second slot gradually departs from the wall of the second slot from the seat toward the plurality of teeth.

8. The ratchet driver of claim 1, wherein the seat further includes a guide wall, the guide wall and the drive rod define a space, and the engaging portion abuts against the guide wall and is linearly and movably inserted in the space.

9. The ratchet driver of claim 1, wherein the driving portion is partially overlapped with the engaging portion, the spring and the seat in the axial direction.

10. The ratchet driver of claim 3, wherein, in the axial direction, a height of the spring is equal to a height of the engaging portion; two sides of the drive rod respectively include a first slot and a second slot recessed in the radial direction, the first slot and the second slot are arranged along the axial direction and in communication with each other, the driving portion is received in the first slot, and the engaging portion, the spring and the seat are received in the second slot; the driving portion is spaced apart from a wall of the first slot; an end of the engaging portion adjacent to the seat laterally abuts against a wall of the second slot, and a side of the engaging portion facing the wall of the second slot gradually departs from the wall of the second slot from the seat toward the plurality of teeth; the seat further includes a guide wall, the guide wall and the drive rod define a space, and the engaging portion abuts against the guide wall and is linearly and movably inserted in the space; the driving portion is partially overlapped with the engaging portion, the spring and the seat in the axial direction; an end of the drive rod away from the grip unit includes a coupling portion configured to be coupled to a tool bit; the first positioning hole, the two second positioning holes and the two pushing portions are respectively located on opposite sides of the rotatable member; one of an outer circumferential wall of the drive rod and an outer circumferential wall of the rotatable member includes a plurality of first marks, and the other of the outer circumferential wall of the drive rod and the outer circumferential wall of the rotatable member includes a second mark, the plurality of first marks respectively radially correspond to the first positioning hole and the two second positioning holes, the second mark radially corresponds to the positioning member, and the second mark is selectively aligned with one of the plurality of first marks in the axial direction; a rugged structure is arranged on the outer circumferential wall of the rotatable member; a bolt passes through the drive rod and is screwed to the base, and the drive rod is rotatable about the bolt; and the seat is assembled to the drive rod.
